(19) United States
(12) Patent Application Publication
(10) Pub. No.: US 2007/0152471 A1
(43) Pub. Date: Jul. 5, 2007

(54) Truck tailgate with internal motion control devices

(76) Inventor: Dimiter S. Zagoroff, Lincoln, MA (US)

Correspondence Address: HAMILTON, BROOK, SMITH & REYNOLDS, P.C., 530 VIRGINIA ROAD, P.O. BOX 9133, CONCORD, MA, 01742-9133, US

(21) Appl. No.: 11/600,305

(22) Filed: Nov. 15, 2006

Related U.S. Application Data
(63) Continuation-in-part of application No. 11/490,836, filed on Jul. 21, 2006.
(60) Provisional application No. 60/701,296, filed on Jul. 21, 2005.

(51) Int. Cl. B62D 33/03

(52) U.S. Cl. 296/146.4; 296/57.1

(57) ABSTRACT

A tailgate has an internal control mechanism used to exert a force on a pivot. The control mechanism may be combined with a torque rod. The rotational force is used to aid in the lowering and/or raising of the tailgate. The internal control mechanism is free from corrosion and debris and therefore allows for greater durability.

### RELATED APPLICATIONS

This application is a continuation-in-part of U.S. application Ser. No. 11/490,836, filed Jul. 21, 2006 which claims the benefit of U.S. Provisional Application No. 60/701,296, filed on Jul. 21, 2005. The entire teachings of the above application are incorporated herein by reference.

### BACKGROUND OF THE INVENTION

Tailgates for pickup trucks typically range in weight from 40 to 60 pounds and are hinged at the rear of a truck bed such that when the tailgate is unlocked by the pulling of a lever or handle, the tailgate opens to a point level with the truck bed where it is restrained, usually by detachable folding straps. Typically, the tailgates can be removed from the truck body when the tailgate is pivoted to a partially open tailgate removal position.

The weight of the tailgate precludes one handed operation for any but the strongest individual. People of normal build have to use their second hand, shoulder or knee to raise the tailgate or to support the tailgate in an effort to keep it from dropping too quickly. Often it is the case where an individual opening a tailgate will only have one free hand, thus causing a strain in the wrist of the individual as the wrist must bear the weight of the tailgate.

Normally a person drops the gate or sometimes raises his or her knee in order to arrest the fall of the tailgate. By so doing, the individual has a chance of being injured if the tailgate falls on the knee by this process. The raising of one's knee to prevent the tailgate from dropping has reportedly resulted in crushed knee caps or other damage to the knee. It will be appreciated that a free falling tailgate can, in fact, crush anything that is underneath it and can, for instance, hurt children who are standing at the back of the tailgate when it falls.

One common solution to counterbalancing the weight of the tailgate is by the use of a torque rod that is fixed to the tailgate at one end and coupled to the truck body at the other end (U.S. Pat. No. 5,358,301, US2005/0194808A1 et al).

Dampers have been employed to achieve a controlled rate of descent. One solution utilizes a spring with viscous damping that is mounted between the tailgate and the truck body and controls the motion of the tailgate with a bell crank and an actuation shaft (U.S. Pat. No. 6,773,047 B2). Another attempted solution has been a power tailgate installation described in U.S. Pat. No. 6,357,813 that consists of a motor mounted on the truck that actuates the tailgate by a crank arm and a sliding component.

### SUMMARY OF THE INVENTION

A problem with prior art methods of counterbalancing the weight of the tailgate is that the additional number of parts necessary to control the tailgate are exposed to road grit and corrosion, thus deteriorating the efficiency of the counter balance. In order to minimize the effects of corrosion, other solutions have mounted the spring and damper internal to the tailgate to provide a protected environment as in U.S. Pat. Nos. 6,820,910 B1 and 6,854,781 B2. Both of these solutions rely on cables that unreel from the interior of the tailgate and attach to the truck body to control its motion. Intricate fair lead mechanisms are required to minimize chafing as the cables unreel from the tailgate in a direction that changes progressively as the tailgate pivots. The cables are exposed when the gate is in the open position. This sliding component complicates the easy removal and installation of the tailgate and the whole mechanism is exposed to road grit and corrosion.

Thus, it would be desirable to control the opening and closure of a tailgate with modules that are internal to the tailgate for protection from corrosion whilst facilitating the easy removal and installation of the tailgate in the conventional way.

According to an aspect of the present invention, motion control devices are mounted inside a tailgate and coupled to a rotating shaft therein, such as a torque rod. Tailgates are generally formed by an inside and an outside panel and a right and left sidewall that defines a box like structure with an enclosed interior space. The tailgate hinges on bushings. A torque rod is generally installed with one end fixed to the tailgate at one side thereof and the other end fixed to a pivot body which rotates inside one of the bushings at the opposite side of the tailgate. The pivot body engages the truck body via an elongated pin that facilitates easy removal of the tailgate but limits rotation relative to the truck body. While the pivot body does not rotate relative to the truck, it does rotate relative to the tailgate as it opens and closes; that is, the pivot body remains fixed to the truck body as the tailgate rotates. A principal feature of this invention is to make use of this relative rotation of the pivot body to control the motion of the tailgate from within the tailgate.

A mechanism mounted inside the tailgate for controlling the drop of a tailgate is described. The control mechanism comprises a damper having a proximal end and a distal end, the proximal end of the damper coupled to a pivot body such as through a crank arm, and the distal end of the damper coupled to the tailgate, such as to a first interior side of the tailgate. The pivot body may attach to a torsion rod inside the tailgate and engage a pin fixed to the truck body outside the tailgate. The damper may comprise a viscous damper or a bumper made of a high hysteresis elastometer.

Another mechanism mounted inside the tailgate for controlling the drop of a tailgate is described. This control mechanism comprises a gas spring having a proximal end and a distal end, the proximal end of the gas spring coupled to a pivot body, such as through a crank arm, and the distal end of the gas spring coupled to the first interior side of the tailgate. The pivot body may rotate inside a bearing inside the tailgate and engage a pin fixed to the truck body outside the tailgate.

A mechanism mounted inside the tailgate for automatically closing the tailgate is also described. The mechanism comprises an electric motor geared to a pivot body. The pivot body may attach to a torsion rod inside the tailgate and engage a pin fixed to the truck body outside the tailgate as described above.

A method and mechanism for providing and a tailgate of a vehicle comprising a pivot, the pivot being fixed relative to a truck bed is disclosed. The tailgate further comprises a rod, the rod being internally mounted in the tailgate, such as on a bottom surface, and being in connectivity with the pivot and a control mechanism, the control mechanism being internally mounted in the tailgate and the control mechanism exerting a force on the rod. The rod in return exerts a rotational force on the pivot. The control mechanism may be in connection to the rod via a crank arm. The rod may be a torque rod or a shaft rod. The control mechanism, as an example, may be a damper, a motor, or a gas spring. The control mechanism may be mounted solely on one end of the tailgate. The rotational force may be used to control the lowering of the tailgate and assist in raising it.

Thus the present invention facilitates ease of closing and safe and controlled opening of the tailgate in various ways, yet permits rapid removal of the tailgate from the truck body in the conventional way, while protecting the mechanism from outside debris.

### BRIEF DESCRIPTION OF THE DRAWINGS

The foregoing and other objects, features and advantages of the invention will be apparent from the following more particular description of preferred embodiments of the invention, as illustrated in the accompanying drawings in which like reference characters refer to the same parts throughout the different views. The drawings are not necessarily to scale, emphasis instead being placed upon illustrating the principles of the invention.

FIGS. 1A and 1B show an internal damper and torque rod disposed within a tailgate;

FIGS. 2A and 2B show an internal gas spring disposed within a tailgate; and

FIGS. 3A and 3B show an internal power mechanism disposed within a tailgate.

### DETAILED DESCRIPTION OF THE INVENTION

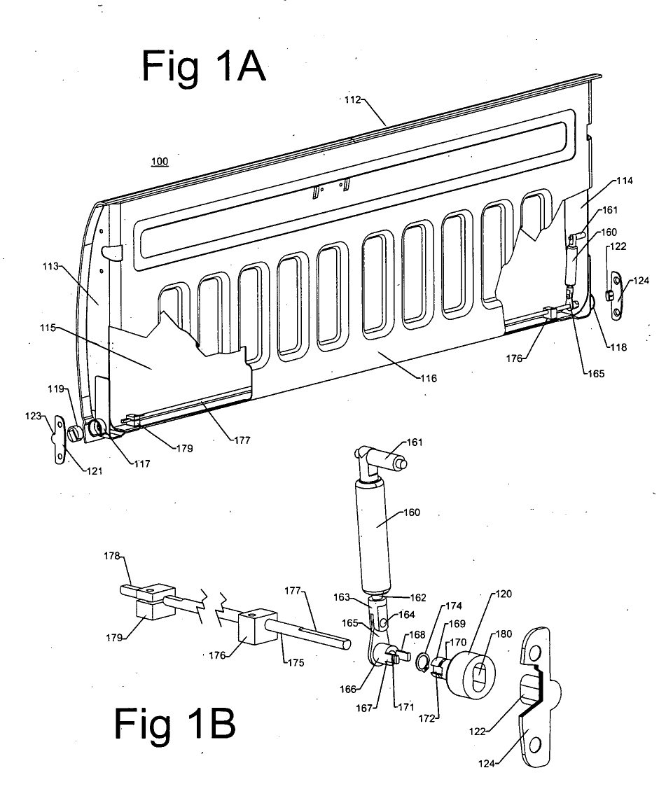

FIGS. 1A and 1B depict a tailgate featuring an internal spring and damping mechanism. FIG. 1B is an enlarged exploded view of the internal mechanism rotated clockwise. The tailgate 112 comprises side faces 113 and 114, outside face 115, and inside face 116 (partially cut away to show the interior of tailgate 112). Tailgate 112 is pivotally attached to the truck body (not shown) by bushings 117 and 118. Bushing 117 houses an insert 119 which mates with a key (hidden in this view) attached to bracket 123. Bracket 123 bolts to the truck body with two flat head bolts (not shown). Bushing 118 on the opposite side of tailgate 112 houses pivot body 120 which mates with key 122 attached to bracket 124. Bracket 124 bolts on to the truck body with two flat head bolts (not shown).

The internal damping mechanism 160 is pivotably attached to the sidewall 114 of tailgate 112 with a stanchion 161. It should be appreciated that the internal damping mechanism may be attached to either sidewall. A piston rod 162 slides in and out of the damper 160. The damper 160 is a viscous damper which exerts a retaining force on the piston rod 162 proportional to the speed of its withdrawal, thus controlling the fall of the tailgate, but only a negligible force to its insertion so as not to inhibit raising of the tailgate. The piston rod 162 terminates in a yoke 163. The yoke 163 is pivotably attached to a crank arm 165 with a pin 164. The crank arm 165 has a boss 166 with a bore for the torque rod 175. Boss 166 terminates in two fingers 167 and 168 that engage the two notches 172 and the second notch, being hidden from view, of the boss 169 of pivot body 120. Thus, through the crank arm, the damper applies a rotating force to the pivot body 120.

Fingers 167 and 168 carry a groove 171 and notches 172 and 173 carry a matching groove 170. Snap ring 174 snaps into the grooves 170 and 171 prevents the fingers from disengaging the notches.

Torque rod 175 has two flats 177 and 178 at each end. Flat 177 mates with a tight fitting bore (not shown) of the boss 169 of pivot body 120. Pivot body 120 has a slot shaped cavity 180 which engages the key 122 of the bracket 124. Flat 178 is retained by pinch block 179 mounted to the far end of the tailgate. In this manner, the pivot body 120 is restrained from rotating as the tailgate is lowered and will impart a proportional twist to the torque rod 175. This twist adds a counterbalancing torque to the weight of the tailgate. An additional restraining torque is applied to the tailgate by the damper 160 and the stanchion 161 as the rod 162 remains attached to the stationary crank arm 165 while the damper 160 and the stanchion 161 orbit around the crank arm 165. This forces the piston rod 162 to withdraw from the damper 160, creating the aforementioned retaining force. This retaining force of the damper 160 can be sized to limit the rate of descent of the tailgate to a controlled rate around 2 to 4 seconds as opposed to a nearly instantaneous drop without a damper. Additional support for the torque rod 175 to resist the thrust loads of the crank arm 165 generated in this process may be provided by a bearing pillow block 176 attached to the tailgate.

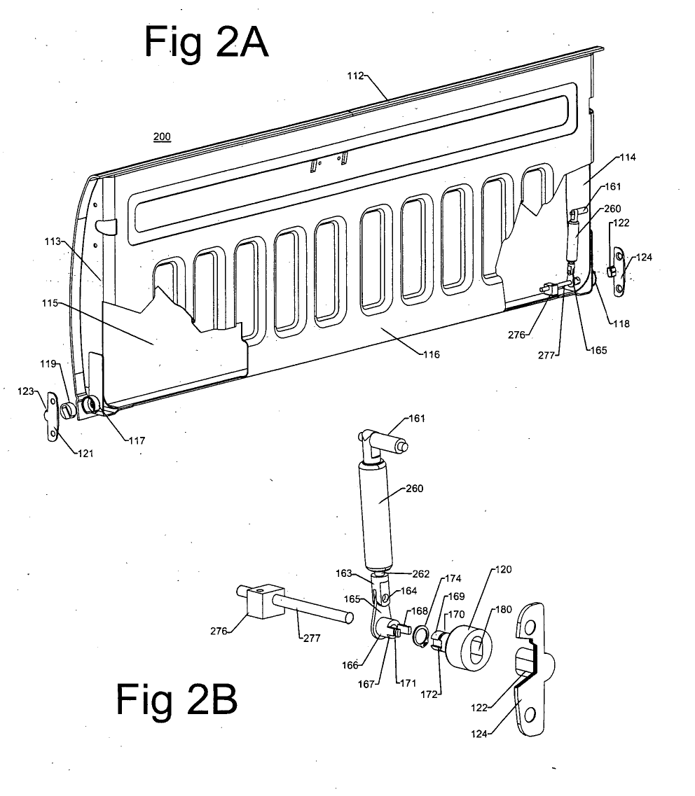

FIGS. 2A and 2B depict a tailgate a mechanism 200 with a gas spring that carries out the functions of the damper and the torque rod described above. Aside from the fact that the torque rod 175 and pinch block 179 are replaced by the shaft 277 and bearing pillow block 276, the two constructions are identical and the numerals used to designate the like components in FIGS. 1A and 1B are carried over in FIGS. 2A and 2B. Gas spring 260 is of the type known as Tension Gas Spring and exerts a spring force that retracts the piston rod 262. Additionally, gas spring 260 acts as a viscous damper which exerts a retaining force on the piston rod 262 proportional to the speed of its withdrawal. Thus, the gas spring exerts a force on the shaft 277 via the crank arm. The shaft in turn exerts a rotation force to the pivot body. The gas spring thus damps lowering of the tailgate and assists in raising it.

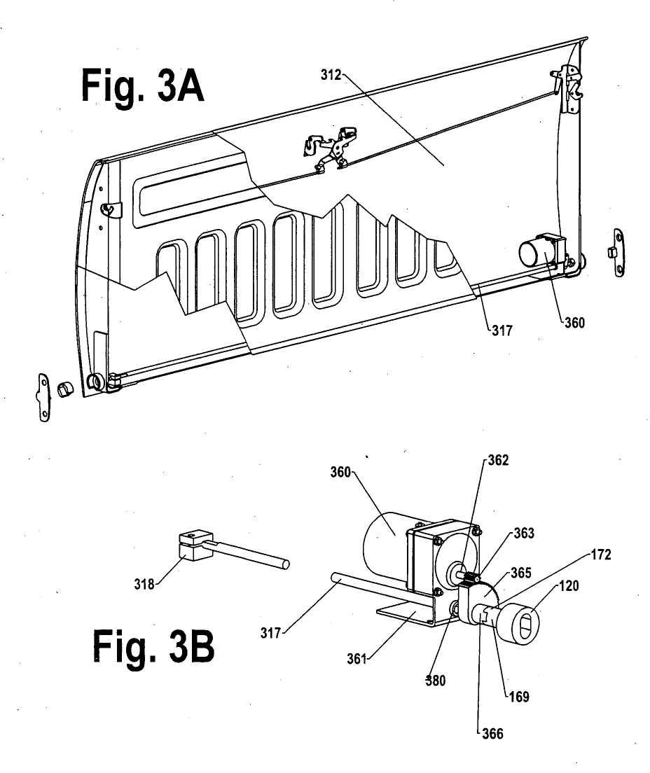

FIGS. 3A and 3B show a tailgate featuring an internal power mechanism 300 which includes a DC motor 360, a pinion gear 363, and a sector gear 365, wherein sector gear 365 is equivalent in terms of operation to crank arm 165. The pinion is attached to an output shaft 362 of the DC motor 360. The sector gear 365 mounts in place of the previously described lever 165 and is driven by the pinion gear 363 on the output shaft 362 of the reduction gear DC motor 360. The sector gear 365 carries a hub 366 with two fingers (hidden in view) that engage the two notches 172 and 173 (hidden in view) of the boss 169 of the pivot body 120. The DC motor 360 mounts on a bracket 361 that attaches to the bottom side of the tailgate 312. The bracket 361 also carries a bearing 380 that retains a torque rod 317 from bending due to the thrust loads of the pinion gears 363 and sector gear 365. The torque rod 317 attaches rigidly to the tailgate 312 inside the pinch block 318. The other end of the torque rod 317 attaches rigidly to the pivot body 120. The torque rod 317 is used to assist the motor 360 in raising the tailgate 312 and also counter balance the gravity forces when the tailgate 312 is lowered. Thus, the DC motor exerts a force on the sector gear, which in return exerts a force on the torque rod. The torque rod then exerts a rotational force on the pivot body. Therefore the sector gear operates in a similar fashion as the crank arm 165. It will be appreciated that the mechanism could also function without the use of a torque rod, alone or in conjunction with a gas spring as described in FIGS. 2A and 2B. The internal friction of the motor 360 can be utilized to slow the descend of the tailgate 312 or an additional damper may be installed as described in FIGS. 1A and 1B.

In operation, the motor 360 causes the pinion gear 363 to rotate, resulting in the rotation of sector gear 365. The rotation of sector gear 365, in turn, causes the rotation of the pivot body 320, thus exerting an opening or closing moment to the tailgate 312 depending on the direction of rotation. The operation of motor 360 may be limited to only raising the tailgate 312 by activating a suitable switch or by remote control. It may also be used to control the descend of the tailgate 312 in conjunction with an apparatus for remote opening of the tailgate as described in U.S. Pat. No. 6,994,390 B2. Motor 360 may also comprise a clutch to disengage it for manual operation.

While this invention has been particularly shown and described with references to preferred embodiments thereof, it will be understood by those skilled in the art that various changes in form and details may be made therein without departing from the scope of the invention encompassed by the appended claims.

The scope of the invention however is not limited to these devices; other mechanical linkages may be employed, such as a cam, a drum and cable or belts or a sprocket and chain. Other motion controllers, such as a rotary damper or a detent to arrest the movement of the tailgate may be installed inside the tailgate and linked to the pivot body. In addition, any combination of the above mentioned embodiments may be used in combination. For example some of the preferred combinations may be, the damper and the torque rod, the gas spring and damper, and the motor in combination with the gas spring. It should also be appreciated that other forms of springs may be used, for example coil or torsion springs.

As may be seen from FIGS. 1A-3B, all of the components of the control motion mechanisms are disposed within the tailgate. Therefore, the control motion mechanisms are protected from cargo and road debris. Furthermore, in order to detach the tailgate from the truck body, it is no longer necessary to detach the individual components of the control motion mechanisms since they are now contained internally in the tailgate.

What is claimed is:

1. A tailgate of a vehicle comprising:
a pivot, the pivot being fixed relative to a truck bed;
a rod, the rod being internally mounted to the tailgate and being in connectivity with the pivot; and
a control mechanism, the control mechanism being internally mounted in the tailgate and the control mechanism exerting a force on the rod, the rod in return exerting a rotational force on the pivot.

2. The tailgate of claim 1, wherein the control mechanism is in connection to the rod via a crank arm.

3. The tailgate of claim 2, wherein the rod is a torque rod.

4. The tailgate of claim 3, wherein the control mechanism is a damper.

5. The tailgate of claim 3, wherein the control mechanism is a motor.

6. The tailgate of claim 3, wherein the control mechanism is a gas spring.

7. The tailgate of claim 1, wherein the control mechanism is mounted solely on one end of the tailgate.

8. The tailgate of claim 1, wherein the rotational force controls lowering of the tailgate.

9. The tailgate of claim 1, wherein the rod is a shaft rod.

10. The tailgate of claim 9, wherein the control mechanism is a gas spring.

11. A method for providing a tailgate comprising:
fixing a pivot to a truck bed;
internally mounting a rod to the tailgate on an inside bottom surface, the rod being in connectivity with the pivot;
internally mounting a control mechanism to the tailgate;
exerting a force on the rod via the control mechanism; and
thereafter exerting a rotational force on the pivot via the rod.

12. The method of claim 11 further comprising:
connecting the control mechanism to the rod via a crank arm.

13. The method of claim 12, wherein the rod is a torque rod.

14. The method of claim 13, wherein the control mechanism is a damper.

15. The method of claim 13, wherein the control mechanism is an electric motor.

16. The method of claim 13, wherein the control mechanism is a gas spring.

17. The method of claim 11 further comprising:
mounting the control mechanism solely to one side of the tailgate.

18. The method of claim 11 further comprising:
controlling a lowering of the tailgate with the rotational force.

19. The method of claim 11, wherein the rod is a shaft rod.

20. The method of claim 19, wherein the control mechanism is a gas spring.

21. A tailgate of a vehicle comprising:
a pivot, the pivot being fixed relative to a truck bed; and
a damper, the damper being internally mounted in the tailgate and the damper exerting a rotational force on the pivot.

22. The tailgate of claim 21, wherein the tailgate further comprises an internal spring.

23. The tailgate of claim 22, wherein the spring is a torque rod.

24. A tailgate of a vehicle comprising:
a pivot, the pivot being fixed relative to a truck bed; and
a motor, the motor being internally mounted in the tailgate exerting a rotational force on the pivot.

25. The tailgate of claim 24, wherein the tailgate further comprises an internal spring.

26. The tailgate of claim 25, wherein the spring is a torque rod.

27. A tailgate of a vehicle comprising:
a pivot, the pivot being fixed relative to a truck bed; and
a gas spring, the gas spring being internally mounted in the tailgate exerting a rotational force on the pivot.
